(19) United States
(12) Patent Application Publication
(10) Pub. No.: US 2007/0165322 A1
(43) Pub. Date: Jul. 19, 2007

(54) Method and apparatus regulating saturation water vapor pressure in a hard disk drive

(75) Inventors: Brian D. Strom, Cupertino, CA (US); Shuyu Zhang, Fremont, CA (US); SungChang Lee, San Jose, CA (US); George Tyndall, San Jose, CA (US)

Correspondence Address: GREGORY SMITH & ASSOCIATES, 3900 NEWPARK MALL ROAD, 3RD FLOOR, NEWARK, CA, 94560, US

(73) Assignee: SAMSUNG ELECTRONICS CO., LTD.

(21) Appl. No.: 11/588,031

(22) Filed: Oct. 25, 2006

Related U.S. Application Data
(63) Continuation-in-part of application No. 11/323,624, filed on Dec. 30, 2005.
Application No. 11/323,624 is a continuation-in-part of application No. 11/453,306, filed on Jun. 13, 2006.
Application No. 11/453,306 is a continuation-in-part of application No. 11/453,267, filed on Jun. 13, 2006.
Application No. 11/453,267 is a continuation-in-part of application No. 11/452,611, filed on Jun. 13, 2006.
Application No. 11/452,611 is a continuation-in-part of application No. 11/452,612, filed on Jun. 13, 2006.
Application No. 11/452,612 is a continuation-in-part of application No. 11/446,573, filed on Jun. 2, 2006.
(60) Provisional application No. 60/816,162, filed on Jun. 23, 2006.

(51) Int. Cl. G11B 19/02; H05B 1/00; H05B 3/00; G11B 21/02

(52) U.S. Cl. 360/69; 360/75; 219/209

(57) ABSTRACT

Method operating hard disk drive (HDD) by receiving temperature and pressure readings from sensors, determining condensation danger from reading and asserting heat-up control to stimulate a thermoelectric device to move heat from exterior to interior thermal zone of HDD. Apparatus implementing method including embedded circuit, embedded processor in embedded circuit, thermal controller, thermal processor in thermal controller, and HDD. Manufacturing methods for apparatus and apparatus as products of these processes.

### CROSS REFERENCE TO RELATED APPLICATIONS

This patent application is a continuation in part of

U.S. patent application Ser. No. 11/323,624, filed Dec. 30, 2005 (docket 139-058U),

U.S. application Ser. No. 11/453,306 filed Jun. 13, 2006 (docket 139-075U),

U.S. application Ser. No. 11/453,267 filed Jun. 13, 2006 (docket 139-076U),

U.S. application Ser. No. 11/452,611 filed Jun. 13, 2006 (docket 139-077U),

U.S. application Ser. No. 11/452,612 filed Jun. 13, 2006 (docket 139-078U),

U.S. application Ser. No. 11/446,573 filed Jun. 2, 2006 (docket 139-092U)

and claims priority to U.S. Provisional Patent Application No. 60/816,162 filed Jun. 23, 2006 (docket 139-101P), all of which are incorporated herein by reference.

### TECHNICAL FIELD

This invention relates to controlling the ambient temperature and humidity in a hard disk drive, in particular to methods and mechanisms determining a condensation danger from temperature and humidity readings and stimulating a thermoelectric device to bring heat into an interior thermal zone including the disks when there is a condensation danger.

### BACKGROUND OF THE INVENTION

Contemporary hard disk drives are faced with severe challenges. They must operate wherever their users decide to operate them, in environments where the hard disk drive must operate outside of room temperature. Much attention has also been focused on the effects of humidity on hard disk drive performance because the reliability of the product is observed to be affected in certain ways by moisture. For example, adsorbed water typically accelerates corrosion of the recording media, requiring the development of thin-film media optimized for both corrosion and recording performance. Humid air also affects the performance of the head-disk interface, both through physical effects and through chemical effects of adsorbed water when the head and media are in contact. To mitigate the negative effects of high humidity in disk drives, moisture adsorbers are commonly included in the design of the hard disk drive enclosure.

The inventors have discovered further problems associated with humidity, which will be discussed in the Summary of the Invention and the Detailed Description which follows. These newly discovered problems need solution approaches, with one approach being the subject of this patent application.

### SUMMARY OF THE INVENTION

Water vapor condensation has recently been discovered by the inventors to cause sudden drops in the flying height of a slider off the rotating disk surface of a hard disk drive in humid conditions. One approach to minimizing this effect is to raise the ambient temperature within the hard disk drive using a thermoelectric device thermally coupled between an interior thermal zone of the hard disk drive and its exterior. Preferably, a temperature sensor and a humidity sensor are used to receive a temperature reading and a humidity reading. These readings are used to determine a condensation danger, and a heat-up control is asserted to stimulate the thermoelectric device to transfer heat from the exterior to the interior thermal zone when the condensation danger is affirmed.

Determining the condensation danger may further include at least one of the following: Affirming the condensation danger for the temperature reading when the humidity reading is above a humidity threshold for the temperature reading. And/or affirming the condensation danger for the temperature reading is below a second top operating temperature. Where the second top operating temperature is below a top operating temperature for the hard disk drive in air below N percent humidity, where N is at most 30.

As used herein, the controller group will consist of an embedded circuit for directing the hard disk drive and a thermal controller for directing the thermoelectric device. This method of operating the hard disk drive may be implemented using only the embedded circuit, or only the thermal controller, or using both embedded circuit and thermal controller.

The embedded circuit may implement this method by including an embedded processor receiving the temperature reading and the humidity reading via a sensor coupling with the temperature sensor and the humidity sensor. The embedded processor determines the condensation danger based upon the temperature reading and the humidity reading. And the embedded processor communicatively asserts the heat-up control via a control coupling to the thermoelectric device to transfer heat from the exterior to the interior thermal zone, both of the hard disk drive, when the condensation danger is affirmed.

The invention includes a method of manufacturing the embedded circuit by providing the embedded processor to create the embedded as a product of this manufacturing process. Frequently, the embedded processor is bonded or coupled to a printed circuit board to create the embedded circuit.

The invention includes the thermal controller for stimulating the thermoelectric device and including at least one of the following: A thermal processor second receiving the temperature reading and the pressure reading via the control coupling from the embedded circuit. The thermal processor third receiving the temperature reading and the humidity reading via the sensor coupling from the temperature sensor and the humidity sensor. And the thermal processor sensing the heat-up control via the control coupling.

The thermal processor may further determine the condensation danger based upon the temperature reading and the humidity reading and stimulate the thermoelectric device to transfer heat from the exterior to the interior thermal zone of the hard disk drive when the condensation danger is affirmed.

The embedded processor and/or the thermal processor may preferably include at least one instance of a controller. As used herein each controller receives at least one input, maintains at least one state and generates at least one output. At least one of the states may be represented by at least one member of a state representation group consisting of a non-redundant digital representation, a redundant digital representation and an analog representation, where the redundant representation includes a numerically redundant representation of the non-redundant digital representation and/or an error control representation of the non-redundant digital representation. As used herein, non-redundant digital representations include but are not limited to groups of digit values, where each digit value represents a member of a collection of value states.

These controllers may each include at least one instance of at least one of the following: A computer directed by a program system and accessibly coupled to via a buss a memory, wherein the program system includes at least one program step residing in the memory. Where the computer includes at least one data processor and at least one instruction processor, and each data processor is directed by at least one of the instruction processors. A finite state machine. An inferential engine. And a neural network.

To clarify the invention, this application will refer to an exemplary embodiment of the embedded processor including at least one instance of a first computer directed by a first program system and first accessibly coupled via a first buss to a first memory. This application will also refer to an exemplary embodiment of the thermal processor including at least one instance of a second computer directed by a second program system and second accessibly coupled via a second buss to a second memory. As used herein, these memories may include a non-volatile memory component, where the contents of a non-volatile memory component are retained without the need to regular supplying of power, whereas the contents of a volatile memory component are lost without regular supplying of power.

The embedded processor may implement this invention's method by including: means for receiving the temperature reading from the temperature sensor and the humidity reading from the humidity sensor, means for determining the condensation danger based upon the temperature reading and the humidity reading, and means for asserting the heat-up control to stimulate the thermoelectric device to transfer heat from the exterior to the interior thermal zone of the hard disk drive, when the condensation danger is asserted.

Manufacturing the embedded processor may include providing the means for receiving, the means for determining, and the means for asserting to create the embedded processor as a product of this manufacturing process. Note that this may preferably be implemented by writing a program step supporting at least one of the means for receiving, the means for determining and the means for asserting, to create the content of the non-volatile memory component of the first memory. Manufacturing the thermal controller includes providing thermal processor to create the thermal controller as a product of this manufacturing process.

The hard disk drive in accord with this invention may include at least one of member of the controller group coupled with the temperature sensor and the humidity sensor, and at least one controller group member coupled with the thermoelectric device, where the thermoelectric device is thermally coupled to the interior thermal zone and to the exterior, both of the hard disk drive.

Manufacturing the hard disk drive includes coupling at least one member of the controller group to the temperature sensor and the humidity sensor to provide the temperature reading and the humidity reading, and coupling at least member of the controller group to the thermoelectric device to create the hard disk drive. The hard disk drive is the product of this manufacturing process.

### BRIEF DESCRIPTION OF THE DRAWINGS

FIG. 1 shows an example of a hard disk drive using an embedded processor in an embedded circuit, temperature sensor, humidity sensor and a thermoelectric device in accord with the invention;

FIG. 2 shows a further example of the hard disk drive of FIG. 1 using a thermal controller;

FIGS. 3A and 3B show an example of a hard disk drive using a thermal processor in an thermal controller, temperature sensor, humidity sensor and a thermoelectric device in accord with the invention;

FIG. 4A shows the controller group consisting of the embedded processor and thermal processor, at least one of which includes at least one instance of a controller;

FIGS. 4B to 5C show some details of the controllers of FIG. 4A;

FIG. 5D shows the embedded processor including at least one instance of the first computer directed by the first program system;

FIG. 5E shows the thermal processor including at least one instance of the second computer directed by the second program system;

FIG. 6A shows further details of the embedded processor;

FIG. 6B shows a flowchart of the first program system of FIG. 5D;

FIG. 7A shows a flowchart of the second program system of FIG. 5E;

FIG. 7A shows some details of determining the condensation danger from the flowcharts of FIGS. 6B and/or 7A;

FIGS. 8 to 11B show examples of the thermoelectric device and its operation;

FIG. 12A shows an external cover including the thermal controller;

FIG. 12B shows the thermoelectric device including the thermal controller;

FIG. 12C shows some further details of the second program system of FIGS. 5E, 7A and 7B;

FIGS. 13A to 13C show the external cover further include a fan driving by the thermal controller; and

FIGS. 14A to 14D show systems including at least one of the invention's hard disk drive coupling to at least one thermal conduit in accord with the invention.

### DETAILED DESCRIPTION

This invention relates to controlling the ambient temperature and humidity in a hard disk drive, in particular to methods and mechanisms determining a condensation danger from temperature and humidity readings and stimulating a thermoelectric device to bring heat into an interior thermal zone including the disks when there is a condensation danger.

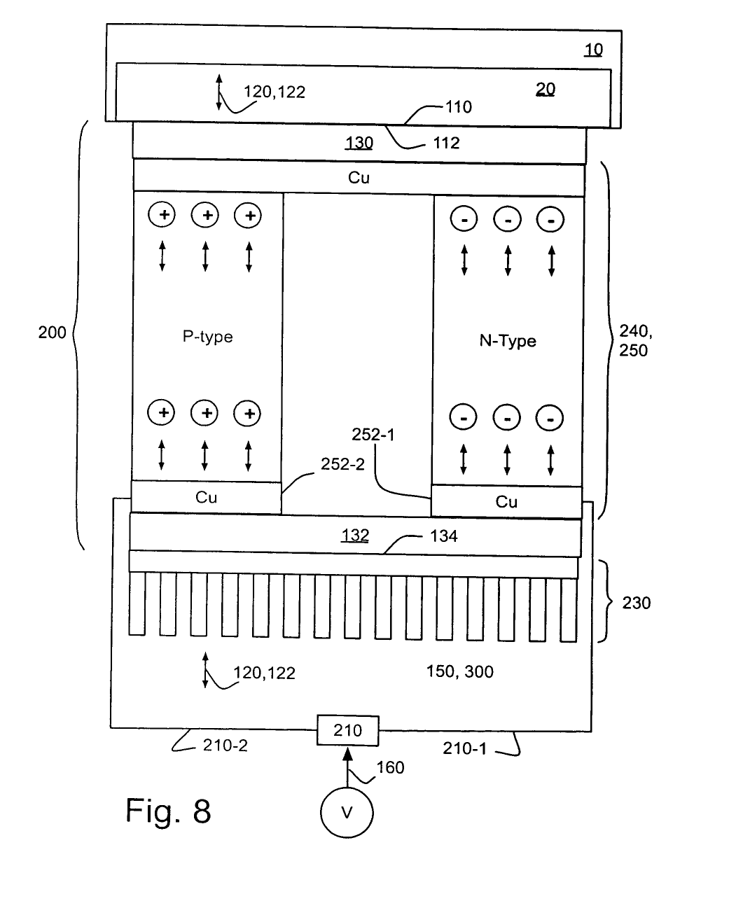

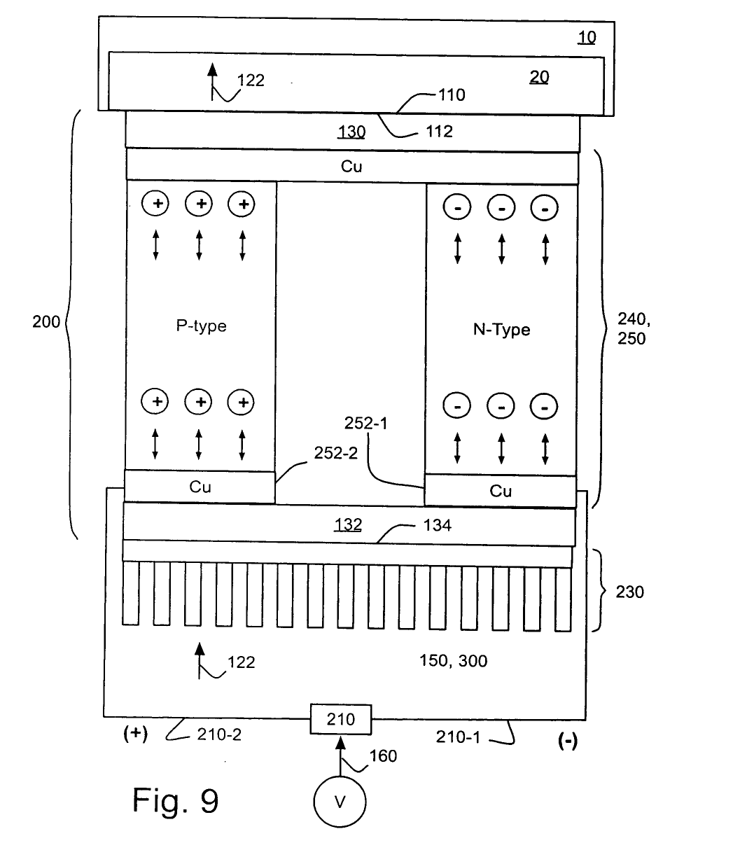

Water vapor condensation has recently been discovered by the inventors (see U.S. Provisional Patent Application No. 60/816,162 filed Jun. 23, 2006) to cause sudden drops in the flying height FH of a slider 90 off the rotating disk surface D120 of a hard disk drive 10 in humid conditions. One approach to minimizing this effect is to raise the ambient temperature within the hard disk drive using a thermoelectric device 200 thermally coupled between an interior thermal zone 20 of the hard disk drive and its exterior 300 as shown in FIGS. 8, 9, and 10. Preferably, a temperature sensor 17T and a humidity sensor 17H are used to receive 700 a temperature reading 170T and a humidity reading 170H. These readings are used to determine 702 a condensation danger 18, and a heat-up control 18HU is asserted 704 to stimulate the thermoelectric device to transfer heat from the exterior to the interior thermal zone when the condensation danger is affirmed. This is referred to as the first heat transfer 120 in the parent patent applications.

Determining the condensation danger may further include at least one of the following: Affirming the condensation danger for the temperature reading when the humidity reading is above a humidity threshold for the temperature reading. And/or affirming the condensation danger for the temperature reading is below a second top operating temperature. Where the second top operating temperature is below a top operating temperature for the hard disk drive in air below N percent humidity, where N is at most 30.

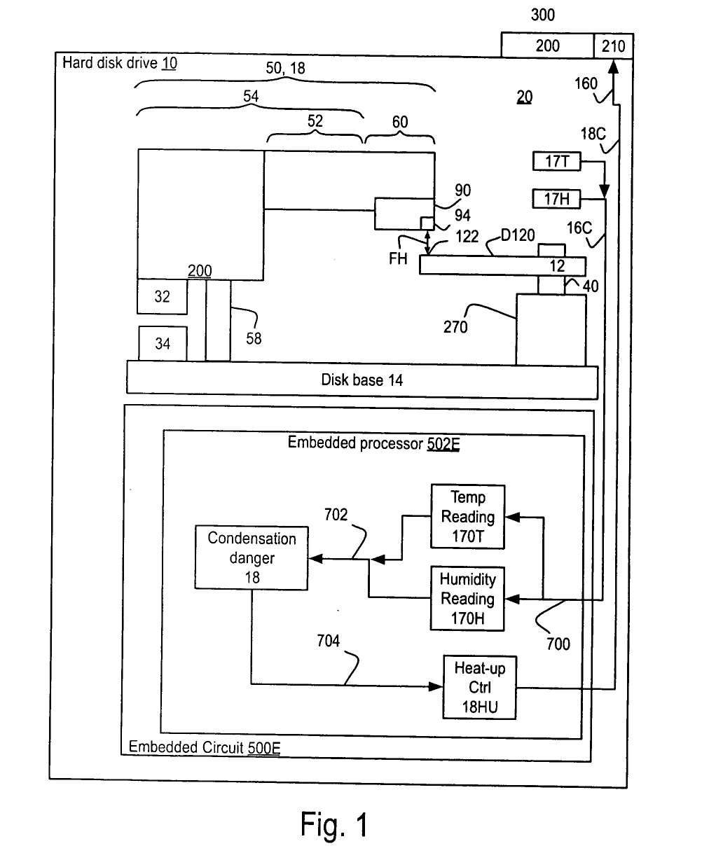

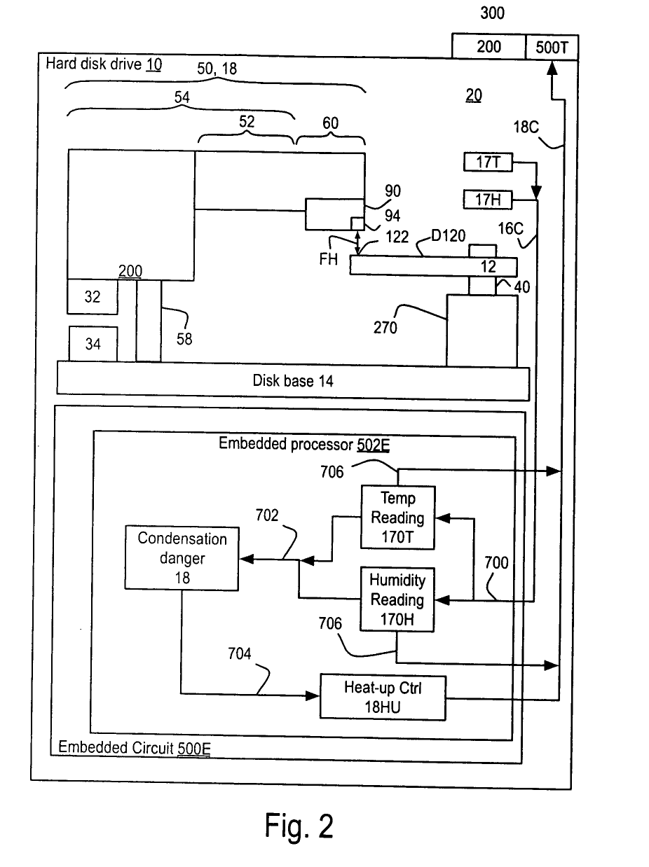

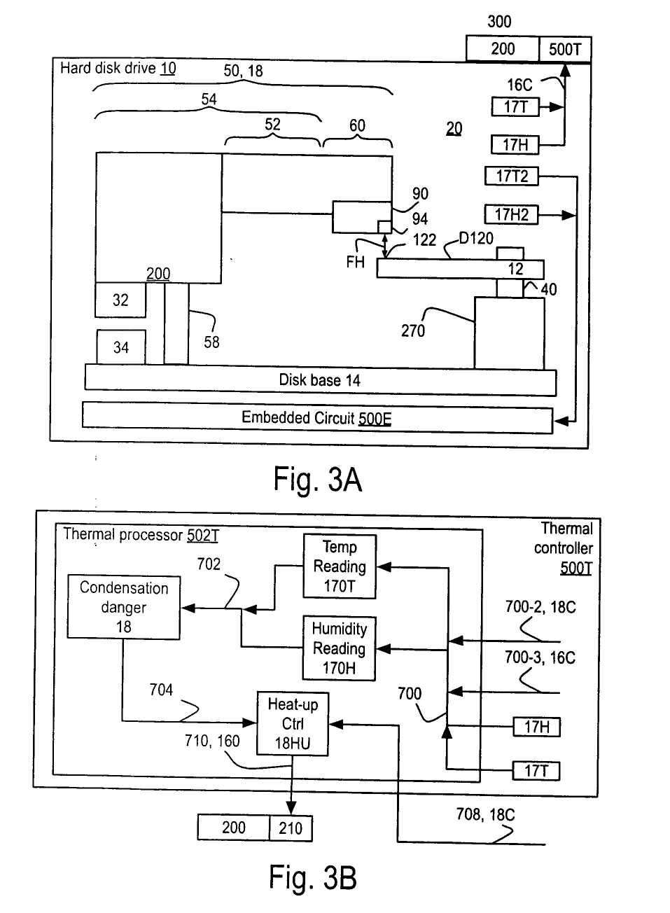

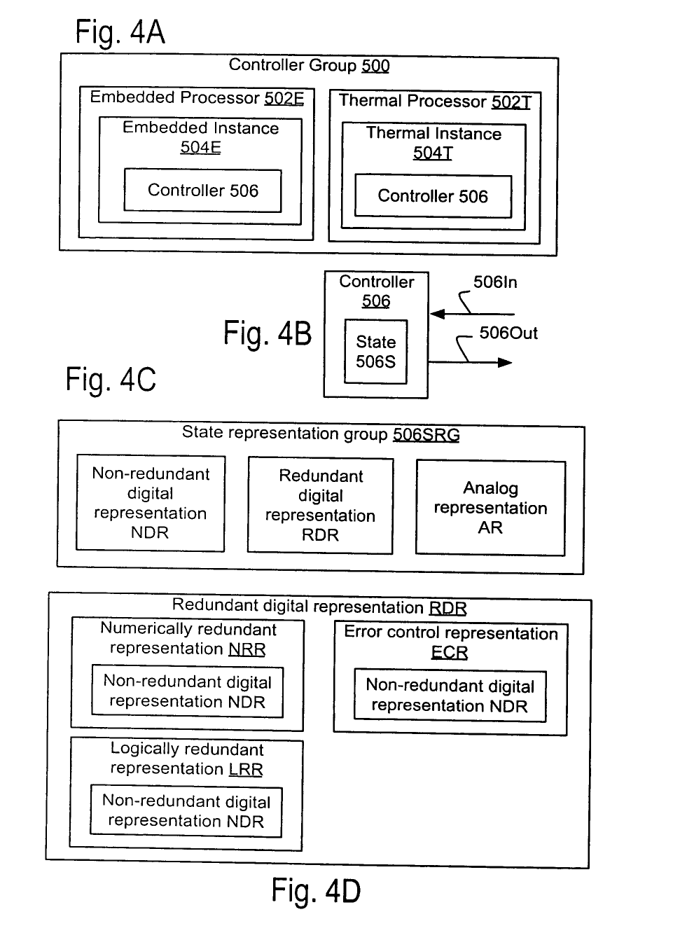

As used herein, the controller group 500 shown in FIG. 4A will consist of an embedded circuit 500E for directing the hard disk drive 10 as shown in FIGS. 1 to 3A and a thermal controller 500T for directing the thermoelectric device 200 as shown in FIGS. 2 to 3B. This method of operating the hard disk drive may be implemented using only the embedded circuit as in FIG. 1, or only the thermal controller as in FIG. 3A, or using both embedded circuit and thermal controller as in FIG. 2.

The embedded circuit 500E may implement this method by including an embedded processor 502E receiving 700 the temperature reading 170T and the humidity reading 170H via a sensor coupling 16C with the temperature sensor 17T and the humidity sensor 17H. The embedded processor determines the condensation danger 18 based upon the temperature reading and the humidity reading. And the embedded processor may preferably communicatively asserts 704 the heat-up control 18 via a control coupling 18C to the thermoelectric device 200 to transfer heat from the exterior 300 to the interior thermal zone 20, both of the hard disk drive 10, when the condensation danger is affirmed.

The invention includes a method of manufacturing the embedded circuit 500E by providing the embedded processor 502E to create the embedded as a product of this manufacturing process. Frequently, the embedded processor is bonded or coupled to a printed circuit board to create the embedded circuit.

The embedded processor 502E communicatively asserting 704 the heat-up control 18HU may include the following. The embedded processor may provide a driving signal 160 based upon the heat-up control via the control coupling 18C to at least one contact 210 of the thermoelectric device 200. The embedded processor may transfer 706 the temperature reading 170T and/or the humidity reading 170H via the control coupling to a thermal controller 502T to provide the driving signal. And/or the embedded processor may communicate the heat-up control via the control coupling to alert the thermal controller to provide the driving signal to stimulate the thermoelectric device.

The invention includes the thermal controller 500T for stimulating the thermoelectric device 200 and may include at least one of the following: A thermal processor 502T second receiving 700-2 the temperature reading 170T and the pressure reading 170H via the control coupling 18C from the embedded circuit 500E. The thermal processor third receiving 700-3 the temperature reading and the humidity reading via the sensor coupling 16C from the temperature sensor and the humidity sensor. And the thermal processor sensing 708 the heat-up control 18HU via the control coupling.

The thermal processor 502T may further determine 702 the condensation danger 18 based upon the temperature reading 170T and the humidity reading 170H and stimulate the thermoelectric device 200 to transfer heat from the exterior 300 to the interior thermal zone 20 of the hard disk drive 10 when the condensation danger is affirmed.

The embedded processor 502E and/or the thermal processor 502T may preferably include at least one instance of a controller 506, as shown in FIG. 4A. The embedded instance 504E of the controller is included in the embedded circuit. The thermal instance 502T of the controller is included in the thermal controller.

As used herein each controller 506 receives at least one input 506In, maintains at least one state 506S and generates at least one output 506Out, as shown in FIG. 4B. At least one of the states may be represented by at least one member of a state representation group 506SRG consisting of a non-redundant digital representation NDR, a redundant digital representation RDR and an analog representation AR, as shown in FIG. 4D.

A redundant digital representation RDR of a non-redundant digital representation NDR may include a numerically redundant representation NRR and/or an error control representation ECR, and/or a logically redundant representation as shown in FIG. 4D. The following examples will serve to illustrate these redundant representations:

An example of a numerically redundant representation NRR may be found in a standard multiplier, which will often use a local carry propagate adder to add three or four numbers together to generate two numeric components which redundantly represent the numeric result of the addition.
An example of an error control representation ECR will frequently use the non-redundant digital representation NDR and an additional component formed as the function of the non-redundant digital representation. If this error control representation is altered by a few number of bits, a error correcting function reconstructs the original non-redundant digital representation. Quantum computers are considered as controllers which will tend to use this kind of error control representations for at least some states.
An example of a logically redundant representation LRR may be found in the definition and implementation of many finite state machines, which often require that a single state be represented by any member of a multi-element set of non-redundant digital representation NDR. Often the members of this set differ from at least one other member of the set by just one bit. Such logically redundant representations are often used to insure that the generation of glitches is minimized.

As used herein, a non-redundant digital representation NDR may include but is not limited to groups of digit values, where each digit value represents a member of a collection of value states. By way of example, a bit is a digit value, being a member of a collection of two value states, often represented as ‘0’ and ‘1’. A byte is a group of eight bits. Often non-redundant digital representations include representations of 16 bit integers, 32 bit integers, 16 bit floating point numbers, 32 bit floating point numbers, 64 bit floating point numbers, strings of bytes, fixed length buffers of bytes, integers, First-In-First-Out (FIFO) queues of such representations, and so on. Any, all and more than just these examples may be used as non-redundant digital representations of the state of a controller 506.

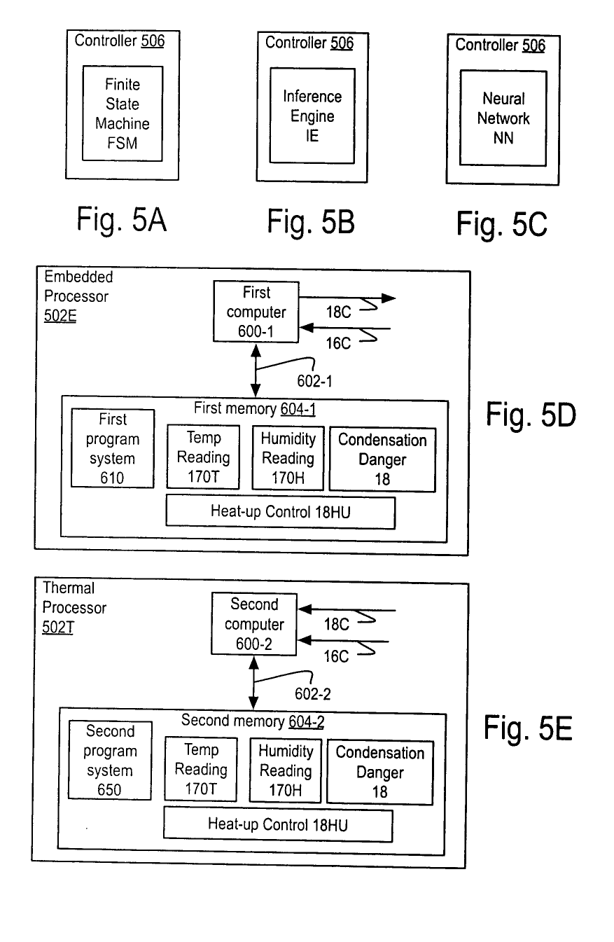

As used herein the controller 506 may include at least one instance of at least one of the following: A finite state machine FSM as shown in FIG. 5A. An inferential engine as shown in FIG. 5B. And a neural network as shown in FIG. 5C.

The controller 506 may include at least one instance of a computer directed by a program system and accessibly coupled to via a buss a memory, wherein the program system includes at least one program step residing in the memory, where the computer preferably includes at least one data processor and at least one instruction processor, and each data processor is directed by at least one of the instruction processors. In greater detail:
To clarify the invention, this application will refer to an exemplary embodiment of the embedded processor 502E including at least one instance of a first computer 600-1 directed by a first program system 610 and first accessibly coupled 602-1 via a first buss to a first memory 604-1 as shown in FIG. 5D. Note that two instances of the first computer may use different instruction sets, requiring different instruction processors and often, different data processors.
This application will also refer to an exemplary embodiment of the thermal processor 502T including at least one instance of a second computer 600-2 directed by a second program system 650 and second accessibly coupled 602-2 via a second buss to a second memory 604-2 as shown in FIG. 5E.
As used herein, these memories may include a non-volatile memory component, where the contents of a non-volatile memory component are retained without the need to regular supplying of power, whereas the contents of a volatile memory component are lost without regular supplying of power.
While these examples have a use in clarifying the detailed specification they are not meant to limit the scope of the claims. By way of example, a finite state machine may include an inferential engine, a neural network may be embodied using a computer, and/or a computer may include an instance of a finite state machine.

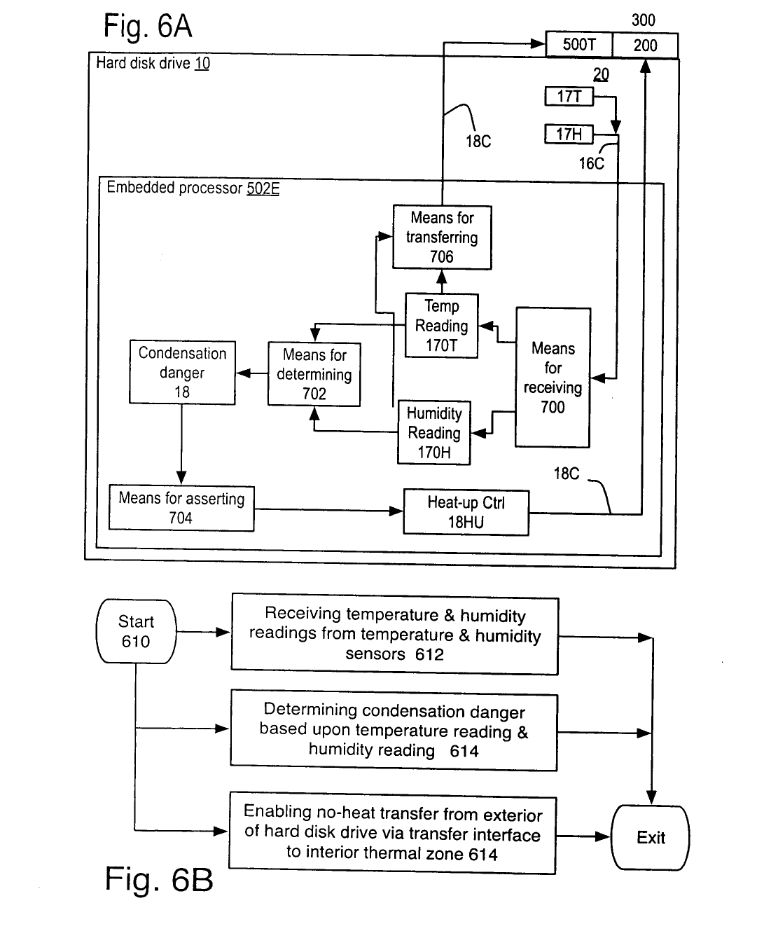

The embedded processor 502E may implement this invention's method by including, as shown in FIG. 6A. Means for receiving 700 the temperature reading 170T from the temperature sensor 17T and the humidity reading 170H from the humidity sensor 17H. Means for determining 702 the condensation danger 18 based upon the temperature reading and the humidity reading. And means for asserting 704 the heat-up control 18HU to stimulate the thermoelectric device 200 to transfer heat from the exterior 300 to the interior thermal zone 20 of the hard disk drive 10, when the condensation danger is asserted.

The embedded processor 502E may further include a means for transferring 706 the temperature reading 170T and the humidity reading 170H to the thermal controller 500T, preferably via the control coupling 18C.

The means for asserting 704 the heat-up control 18HU may include at least one of the following: Means for providing a driving signal 160 to at least one contact 210 of the thermoelectric device 200, similar to FIG. 3B. Means for transferring 706 the temperature reading 170T and the humidity reading 170H to a thermal controller 500T to provide the driving signal. And means for communicating the heat-up control to alert the thermal controller to provide the driving signal and stimulate the thermoelectric device.

Some of the following figures show flowcharts of at least one method of the invention, possessing arrows with reference numbers. These arrows will signify of flow of control and sometimes data supporting implementations including:
at least one program operation or program thread executing upon a computer 600,
at least one inferential link in an inferential engine IE,
at least one state transitions in a finite state machine FSM,
and/or at least one dominant learned response within a neural network NN.

The operation of starting a flowchart is designated by an oval with the text “Start” in it, and refers to at least one of the following:
Entering a subroutine in a macro instruction sequence in a computer 600.
Entering into a deeper node of an inferential graph of an inference engine IE.
Directing a state transition in a finite state machine FSM, possibly while pushing a return state.
And triggering a list of at least one neuron and/or at least one synaptic connection in a neural network NN.

The operation of termination in a flowchart is designated by an oval with the text “Exit” in it, and refers to the completion of those operations, which may result in at least one of the following:
return from a subroutine in a computer 600,
traversal of a higher node in the inferential graph of an inference engine IE,
popping of a previously stored state in a finite state machine FSM,
and/or return to dormancy of the firing neurons of the neural network NN.

The first program system 610 directing an instance of the first computer 602-1 of FIG. 5D may include at least one of the following operations shown in FIG. 6B:
Operation 612 supports receiving 700 the temperature reading 170T from the temperature sensor 17T and the humidity reading 170H from the humidity sensor 17H.
Operation 614 supports determining 702 the condensation danger 18 based upon the temperature reading and the humidity reading.
And operation 616 supports asserting the heat-up control 18HU to stimulate the thermoelectric device 200 to transfer heat from the exterior 300 to the interior thermal zone 20, when the condensation danger is affirmed.
The first program system may further include each of these operations.

At least one of the means for asserting 704, means for determining 702 and/or the means for receiving 700 may include an embedded instance 504E of the controller 506, which may further include at least one instance of the first computer 600-1 directed by the first program system 610, the finite state machine FSM, the neural network NN and/or the inferential engine IE, similarly to the embedded processor 502E as shown in FIGS. 4A, and 5A to 5D.

Manufacturing the embedded processor 502E may include providing the means for receiving 700, the means for determining 702, and the means for asserting 704 to create the embedded processor as a product of this manufacturing process. Note that this may preferably be implemented by writing a program step supporting at least one of the means for receiving, the means for determining and the means for asserting, to create the content of the non-volatile memory component of the first memory 604-1.

The thermal processor 502T preferably stimulates the thermoelectric device 200 and may include at least one of the following: Means for second receiving 700-2 the temperature reading 170T and the humidity reading 170H from the embedded circuit 500E, as shown in FIG. 3B. Means for third receiving 700-3 the temperature reading and the humidity reading from the temperature sensor and the humidity sensor, preferably via the sensor coupling 16C. And means for sensing 708 the heat-up control 1 8HU to alert the thermal controller 500T to stimulate the thermoelectric device.

The thermal processor 502T may further include the following as shown in FIG. 3B. Means for determining 702 the condensation danger 18 based upon the temperature reading 170T and the humidity reading 170H. And means for stimulating 710 the thermoelectric device 200 to transfer heat from the exterior 300 to the interior thermal zone 20, both of the hard disk drive 10, when the condensation danger is affirmed.

As used herein, the second thermal controller means group, consists of: the means for second receiving 700-2, the means for third receiving 700-3, the means for sensing 708, the means for determining 702 and the means for stimulating 710. At least one member of the second thermal controller means group may preferably include at least one of the thermal instance 504T of the controller 506, which as before may further include at least one instance of the finite state machine FSM, the neural network NN, the inferential engine EE and/or the second computer 600-2 directed by the second program system 650, as shown in FIGS. 4A, 5A to 5C, and 5E.

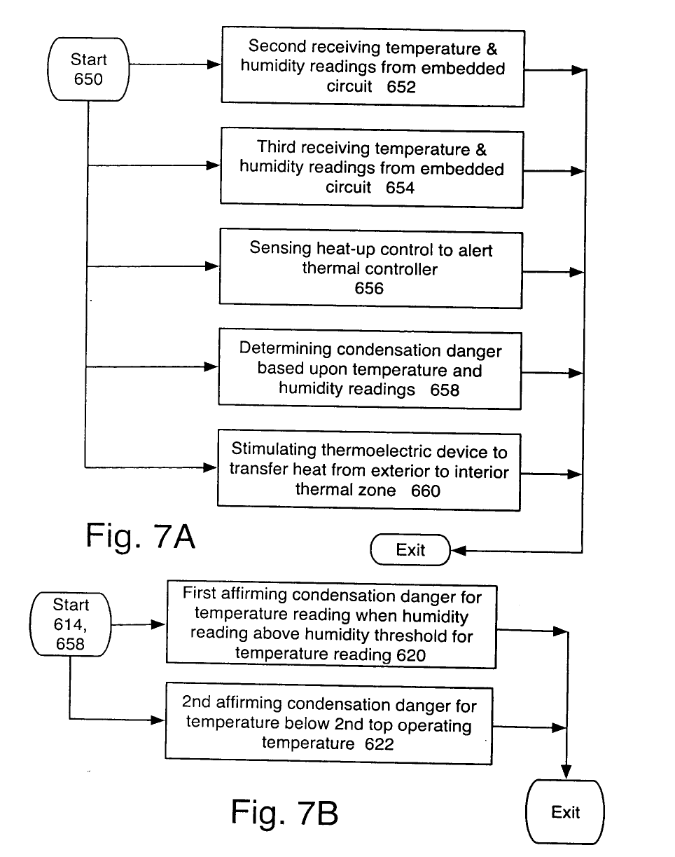

The second program system 650 may include at least one of the following operations as shown in FIG. 7:
Operation 620 supports second receiving 700-2 the temperature reading 170T and the humidity reading 170H from the embedded circuit 500E.
Operation 654 supports third receiving 700-3 the temperature reading and the humidity reading from the temperature sensor 17T and the humidity sensor 17H, preferably via the sensor coupling 16C.
Operation 656 supports sensing 708 the heat-up control 18HU to alert the thermal controller 500T.
Operation 658 supports determining 702 the condensation danger 18 based upon the temperature reading 170T and the humidity reading 170H.
And operation 660 supports stimulating 710 the thermoelectric device 200 to transfer heat from the exterior 300 to the interior thermal zone 20, both of the hard disk drive 10, when the condensation danger is affirmed.

Determining 702 the condensation danger 18 may be supported by operation 614 in the first program system 610 as shown in FIG. 6B and/or operation 658 in the second program system 650 as shown in FIG. 7A, either or both of which may further include at least one of the following operations of FIG. 7B:
Operation 620 supports first affirming 706-1 the condensation danger for the temperature reading when the humidity reading is above a humidity threshold 19H for the temperature reading.
Operation 622 supports second affirming 706-2 the condensation danger for the temperature reading is below a second top operating temperature 512-2. Where the second top operating temperature is preferably below a top operating temperature 512 for the hard disk drive 10 in air below N percent humidity, where the N is at most 30.

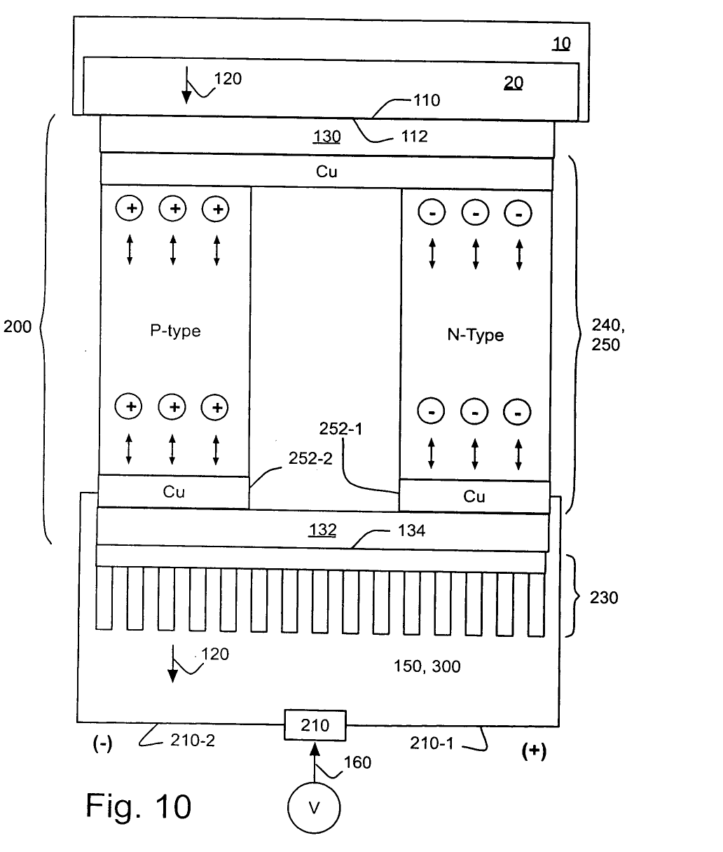

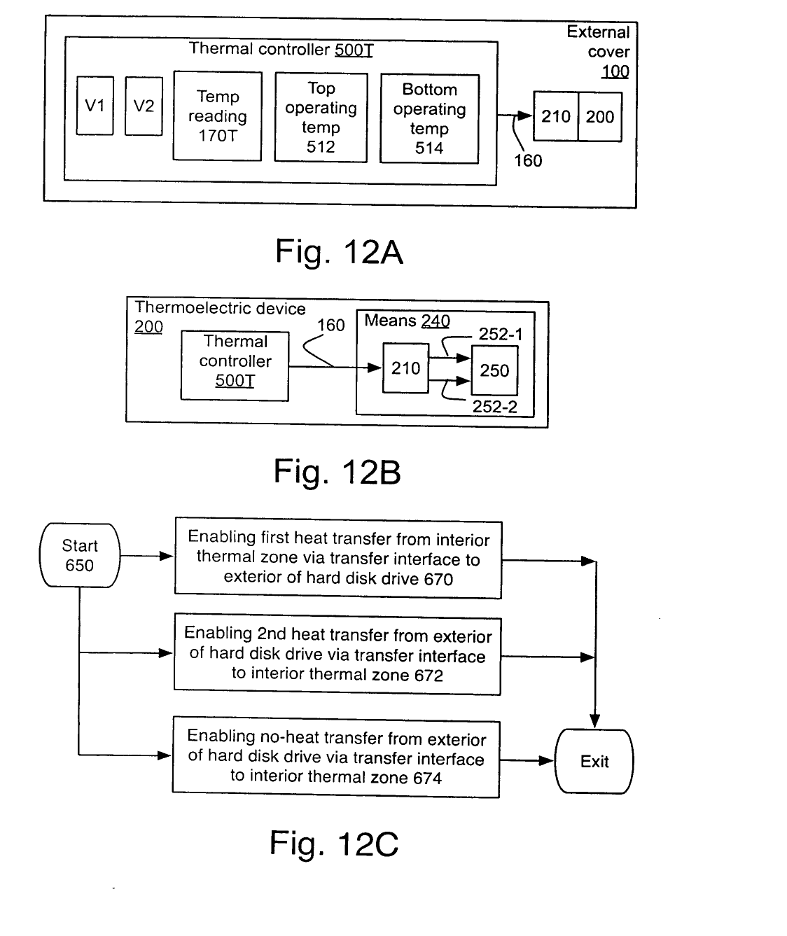

As previously stated in the parent applications, the thermal controller 500T, in particular and preferably, the thermal processor 502T operates the thermoelectric device 200 to control heat flow into and out of the hard disk drive. This can be seen in the example flowchart of the second program system 650 shown in FIG. 12C:
Operation 670 supports enabling the first heat transfer 120 from the interior thermal zone 20 via the transfer interface 110 to the exterior 300 of the hard disk drive 10, as shown in FIG. 10. This operation may preferably be active when the temperature reading 170T is above the top operating temperature 512 of FIG. 12A.
Operation 672 supports enabling the second heat transfer 122 from the exterior of the hard disk drive via the transfer interface to the interior thermal zone. This operation may preferably be active when the temperature reading is below the bottom operating temperature 514,
And operation 674 supports enabling no-heat transfer from the exterior of the hard disk drive via the transfer interface to the interior thermal zone. This operation may preferably be active when the temperature reading is between the bottom temperature and the top temperature and the condensation danger is not affirmed.

Manufacturing the thermal processor 502T may include providing at least one member of the second thermal controller means group to create the thermal processor as a product of this manufacturing process. At least one of the provided members may be implemented by programming a non-volatile memory component of the second memory 604-2.

Manufacturing the thermal controller 500T may include providing the thermal processor to create the thermal controller as a product of this manufacturing process. Often providing the thermal processor includes coupling the thermal processor to a printed circuit to further create the thermal controller.

The hard disk drive 10 in accord with this invention may include at least one of member of the controller group 500 coupled with the temperature sensor 17T and the humidity sensor 17H, and at least one controller group member coupled with the thermoelectric device 200, where the thermoelectric device is thermally coupled to the interior thermal zone 20 and to the exterior 300, both of the hard disk drive.

By way of example, the hard disk drive 10 may include the embedded circuit 500E coupled with the temperature sensor 17T and the humidity sensor 17H, and the embedded circuit coupled with the thermoelectric device 200 to stimulate the thermoelectric device to transfer heat from the exterior 300 to the interior thermal zone 20 of the hard disk drive when the condensation danger 18 is affirmed, as shown in FIG. 1.

Another example, the hard disk drive 10 may include the embedded circuit 500E coupled with the temperature sensor 17T and the humidity sensor 17H, and the thermal controller 500T coupled with the thermoelectric device 200 to stimulate the thermoelectric device to transfer heat from the exterior 300 to the interior thermal zone of the hard disk drive when the condensation danger 18 is affirmed, as shown in FIGS. 2, 3B and 6A. The embedded circuit may provide at least one member of a signal group to the thermal controller, where the signal group, consists of: the heat-up control 18HU, a version of the humidity reading 170T, and a version of the temperature reading 170H.

Another example, the hard disk drive 10 may include the thermal controller 500T coupled with the temperature sensor 17T and the humidity sensor 17H as shown in FIGS. 3A and 3B, and the thermal controller coupled with the thermoelectric device 200 to stimulate 710 the thermoelectric device to transfer heat from the exterior 300 to the interior thermal zone 20 of the hard disk drive when the condensation danger 18 is affirmed.

The hard disk drive 10 may further include a second temperature sensor 17T2 and a second humidity sensor 17H2, both coupled to the embedded circuit 500E. Alternatively, the hard disk drive may include a third temperature sensor and/or a third humidity sensor sampling the exterior.

Manufacturing the hard disk drive 10 includes coupling at least one member of the controller group 500 to the temperature sensor 17T and the humidity sensor 17H to provide the temperature reading 170T and the humidity reading 170H, and coupling at least one member of the controller group to the thermoelectric device 200 to create the hard disk drive as the product of this manufacturing process.

Coupling the at least one member of the controller group 500 to the temperature sensor 17T and the humidity sensor 17H may include one of the following: coupling the embedded circuit 500E to the temperature sensor and the humidity sensor to provide the temperature reading 170T and the humidity reading 170H, coupling the thermal controller 500T to the temperature sensor and the humidity sensor to provide the temperature reading and the humidity reading, and/or coupling both the embedded circuit and the thermal controller to the temperature sensor and the humidity sensor to provide the temperature reading and the humidity reading.

Coupling the at least one member of the controller group 500 to the thermoelectric device 200 to create the hard disk drive 10 may include coupling the embedded circuit 500E to the thermoelectric device to create the hard disk drive, and/or coupling the thermal controller SOOT to the thermoelectric device to create the hard disk drive.

As previously stated in one or more of the parent applications and shown in FIGS. 8 to 10: the thermoelectric device 200 may preferably include a contact 210, preferably an electrical contact pair 210 providing enabling power for a first heat transfer 120 from the transfer interface 110 to the second heat transfer interface 132, and a second heat transfer 122 from the second heat transfer interface to the transfer interface. Preferably, applying a first potential difference V1 between the electrical contact pair enables the first heat transfer, and applying a second potential difference V2 between the electrical contact pair enables the second heat transfer. Preferably, the sign of the first potential difference is opposite the sign of the second potential difference.

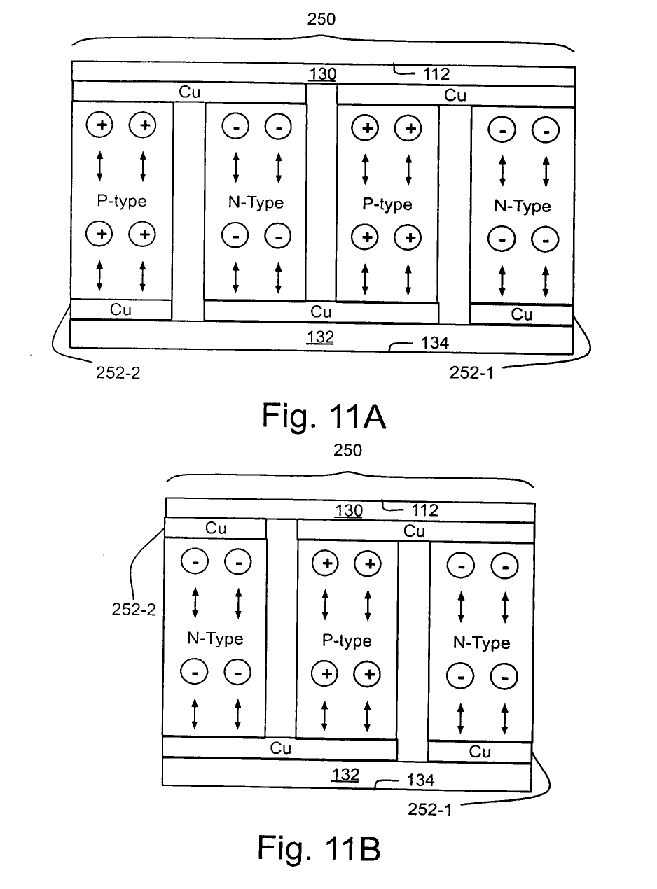

The thermoelectric device 200 may include at least one instance of a semiconductor device 250 acting as a heat pump and using the transfer interface 110 to thermally-affect the interior thermal zone 20 as shown in FIGS. 8 to 10. The thermoelectric device 200 may include at least two semiconductor devices as shown in FIGS. 11A and 11B and further discussed in the parent applications. Alternatively the thermoelectric device may include at least one instance of a thermal-resistive device, which preferably exchanges electrical energy from the hard disk drive exterior to transfer heat into the interior thermal zone.

The thermoelectric device 200 operates as follows. It enables a first heat transfer 120 from the interior thermal zone 20 via the transfer interface 110 to the exterior 300 of the hard disk drive 10, and enables a second heat transfer 122 from the exterior of the hard disk drive via the transfer interface to the interior thermal zone, which is preferred in this patent application. The driving signal 160 may preferably be provided to the electrical contact pair 210 coupling to the thermoelectric device to enable the first heat transfer, the second heat transfer, or essentially no-heat transfer.

Pulse-width-modulation may be employed. Forcing the driving signal 160 toward the first potential difference V1 may preferably include pulse-width-modulating the driving signal between the first potential difference and zero volts, preferably based upon the temperature reading. Forcing the driving signal toward the second potential difference V2 may preferably include pulse-width-modulating the driving signal between the second potential difference and zero volts, preferably based upon the temperature reading.

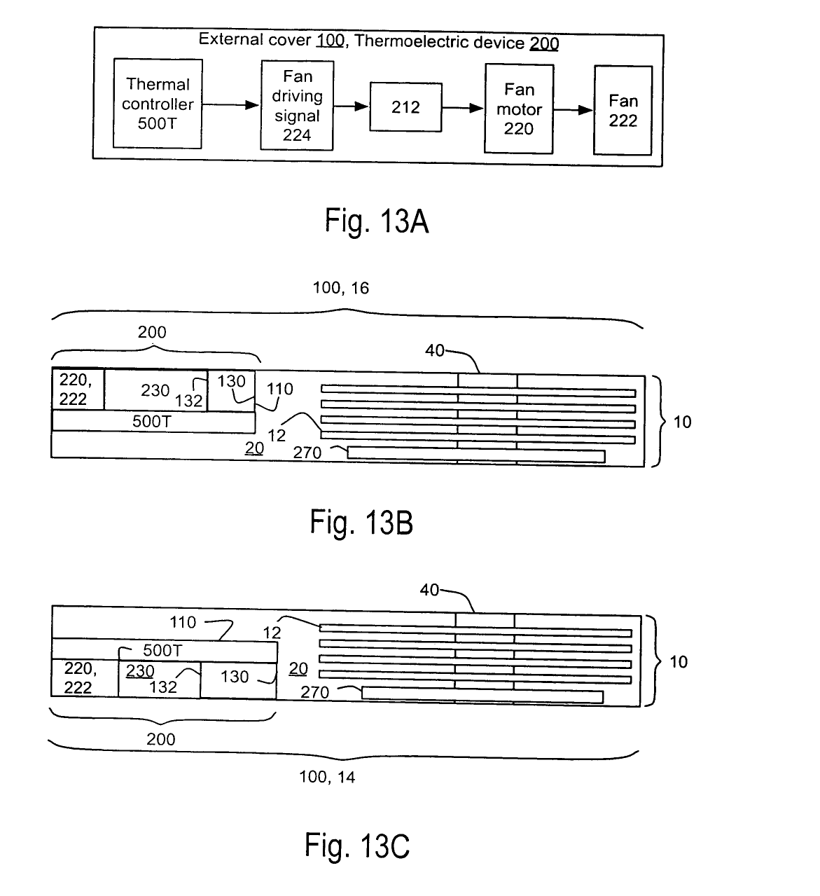

An external cover 100 may include the thermal controller 500T as shown in FIG. 12A. The external cover may include a transfer interface 110 thermal-coupling 112 to the interior thermal zone 20 to a thermoelectric device 200. A disk cover 16 and/or a disk base 14 may serve as the external cover for the hard disk drive 10 as shown in FIGS. 13B, 13C, 14G, and 15A to 15C. The thermoelectric device may preferably provide the two heat transfers across the transfer interface to the exterior of the hard disk drive, into the interior thermal zone to warm it, which is used in this invention's method, and out of the interior thermal zone to cool it. The interior thermal zone 20 may preferably include at least one disk surface D120, and may preferably further include all the disk surfaces and sliders 90 moving near the disk surfaces.

The transfer interface 110 may provide a nearly planar surface to the thermoelectric device 200. The planar surface may have a surface area of at least one square inch. The surface area may further be at most four square inches.

The external cover 100 may further include a second electrical contact pair 212 driving a fan motor 220 powering a fan 222 to move air across a thermal transfer element exterior 300 to the hard disk drive 10, as shown in FIGS. 13A to 13C. The thermal controller may further provide a fan driving signal to the second electrical contact pair. The thermal controller 500T may preferably provide the fan driving signal with at least one fan potential difference distinct from zero volts, when the temperature reading is either greater than the top operating temperature or less than the bottom operating temperature. The fan driving signal may be at least temporarily a Direct Current (DC) signal and/or an Alternating Current (AC) signal.

Manufacturing the hard disk drive 10 may further include at least one of the following. Using the disk cover 16 as the external cover 100 to create the hard disk drive. Using the disk base 14 as the external cover to create the hard disk drive. The manufacturing may include using both the disk cover and the disk base as external covers for the hard disk drive.

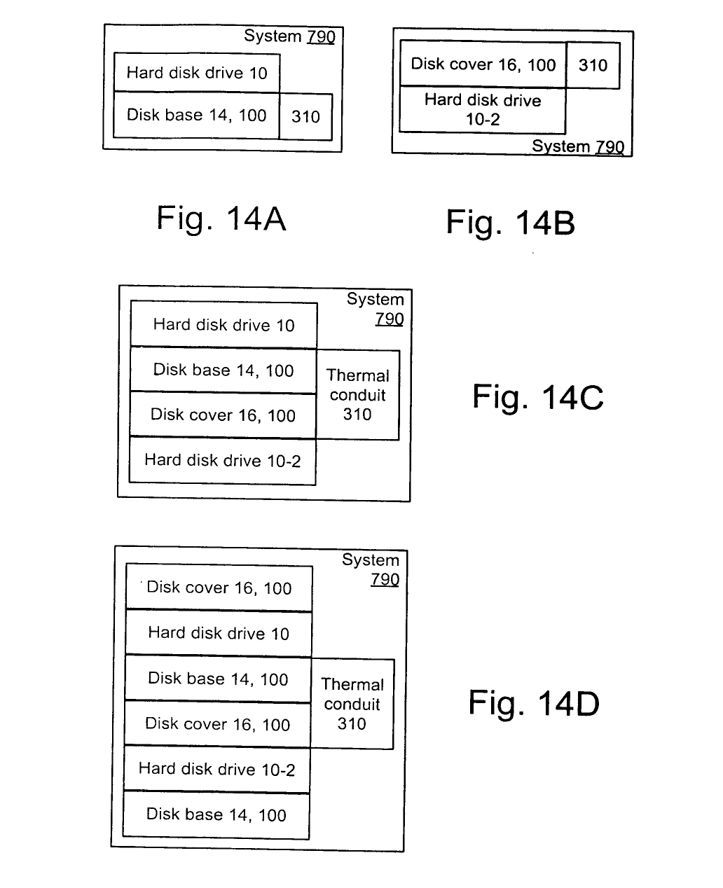

The invention includes the use of the invention's hard disk drive 10 in a system 790, as shown in FIGS. 14A to 14D, where the disk base 14 and/or the disk cover 16 may be coupled to a thermal conduit 310 supporting the transfer of heat into or out of the interior thermal zone 20 of the hard disk drives.

The preceding embodiments provide examples of the invention and are not meant to constrain the scope of the following claims.

What is claimed is:

1. A method, comprising the steps:
receiving a temperature reading from a temperature sensor and a humidity reading from a humidity sensor; wherein said temperature sensor and said humidity sensor are included in a hard disk drive;
determining a condensation danger based upon said temperature reading and said humidity reading; and
asserting a heat-up control to stimulate a thermoelectric device to transfer heat from an exterior to an interior thermal zone, both of said hard disk drive, when said condensation danger is affirmed;
wherein said hard disk drive comprises said interior thermal zone including each slider accessing a rotating disk surface within said hard disk drive.

2. The method of claim 1, wherein the step determining said condensation danger, further comprises at least one member of the group consisting of the steps:
affirming said condensation danger for said temperature reading when said humidity reading is above a humidity threshold for said temperature reading; and
affirming said condensation danger for said temperature reading is below a second top operating temperature;
wherein said second top operating temperature is below a top operating temperature for said hard disk drive in air below N percent humidity; wherein said N is at most 30.

3. An embedded circuit for directing said hard disk drive to implement the method of claim 1, comprising:
an embedded processor receiving said temperature reading and said humidity reading via a sensor coupling with said temperature sensor and said humidity sensor;
wherein said embedded processor determines said condensation danger based upon said temperature reading and said humidity reading; and
wherein said embedded circuit, further comprises:
said embedded processor communicatively asserts said heat-up control via a control coupling to said thermoelectric device to transfer heat from said exterior to said interior thermal zone, both of said hard disk drive, when said condensation danger is affirmed.

4. The embedded circuit of claim 3, wherein said embedded processor communicatively asserts said heat-up control via said control coupling to said thermoelectric device, comprises a member of the group consisting of:
said embedded processor providing a driving signal based upon said heat-up control via said control coupling to at least one contact of said thermoelectric device;
said embedded processor transferring said temperature reading and said humidity reading via said control coupling to a thermal controller to provide said driving signal; and
said embedded processor communicating said heat-up control via said control coupling to alert said thermal controller to provide said driving signal to stimulate said thermoelectric device.

5. A method of manufacturing said embedded controller of claim 3, comprising the step:
providing said embedded processor to create said embedded circuit.

6. The embedded circuit as a product of the process of claim 5.

7. The embedded processor of claim 3, comprising:
means for receiving said temperature reading from said temperature sensor and said humidity reading from said humidity sensor;
means for determining said condensation danger based upon said temperature reading and said humidity reading; and
means for asserting said heat-up control to stimulate said thermoelectric device to transfer heat from said exterior to said interior thermal zone, both of said hard disk drive, when said condensation danger is asserted.

8. The embedded processor of claim 7, wherein said means for asserting said heat-up control, comprises a member of the group consisting of:
means for providing a driving signal to at least one contact of said thermoelectric device;
means for transferring said temperature reading and said humidity reading to a thermal controller to provide said driving signal; and
means for communicating said heat-up control to alert said thermal controller to provide said driving signal and stimulate said thermoelectric device.

9. A method of manufacturing said embedded processor of claim 7, comprising the step:
providing said means for receiving, said means for determining, and said means for asserting to create said embedded processor.

10. The embedded processor as a product of the process of claim 9.

11. The thermal controller for stimulating said thermoelectric device of claim 4, comprising at least one member of the group consisting of:
a thermal processor second receiving said temperature reading and said humidity reading via said control coupling from said embedded circuit;
said thermal processor third receiving said temperature reading and said humidity reading via said sensor coupling from said temperature sensor and said humidity sensor; and
said thermal processor sensing said heat-up control via said control coupling.

12. The thermal controller of claim 11, wherein said thermal processor determines said condensation danger based upon said temperature reading and said humidity reading; and
wherein said thermal processor stimulates said thermoelectric device to transfer heat from said exterior to said interior thermal zone, both of said hard disk drive, when said condensation danger is affirmed.

13. The embedded processor and said thermal processor of claim 8, each comprise: at least one instance of a controller receiving at least one input, maintaining at least one state and generating at least one output;
wherein at least one of said states is represented by at least one member of a state representation group consisting of: a non-redundant digital representation, a redundant representation, and an analog representation;
wherein said redundant representation includes at least one member of the group consisting of: a numerically redundant representation of said non-redundant digital representation and an error control representation of said non-redundant digital representation.

14. The embedded processor of claim 13, wherein said controller may include at least one instance of at least one member of the group consisting of:
a computer directed by a program system and accessibly coupled to a memory, wherein said program system includes at least one program step residing in said memory;
a finite state machine;
an inferential engine;
a neural network;
wherein said computer includes at least one data processor and at least one instruction processor; wherein each of said data processors is directed by at least one of said instruction processors; and wherein said computer is accessibly coupled via a buss to said memory.

15. The embedded processor of claim 14, wherein said program system, comprises at least one member of the group consisting of the program steps:
receiving said temperature reading from said temperature sensor and said humidity reading from said humidity sensor;
determining said condensation danger based upon said temperature reading and said humidity reading; and
asserting said heat-up control to stimulate said thermoelectric device to transfer heat from an exterior to an interior thennal zone, both of said hard disk drive, when said condensation danger is affirmed.

16. The embedded processor of claim 15, wherein said program system, comprises the program steps:
receiving said temperature reading from said temperature sensor and said humidity reading from said humidity sensor;
determining said condensation danger based upon said temperature reading and said humidity reading; and
asserting said heat-up control to stimulate said thermoelectric device to transfer heat from said exterior to said interior thermal zone, when said condensation danger is asserted.

17. The thermal processor of claim 13, wherein said controller includes at least one instance of a member of the group consisting of:
a finite state machine;
a second computer second accessibly coupled via a second buss to a second memory and directed by a second program system comprising at least one program step residing in said second memory;
a communications interface for communicatively coupling to at least one member of the group consisting of: said embedded circuit, said temperature sensor, and said humidity sensor.

18. The second program system of claim 17, comprising at least one member of the group consisting of the program steps:
second receiving said temperature reading and said humidity reading from said embedded circuit;
third receiving said temperature reading and said humidity reading from said temperature sensor and said humidity sensor;
sensing said heat-up control to alert said thermal controller;
determining said condensation danger based upon said temperature reading and said humidity reading; and
stimulating said thermoelectric device to transfer heat from said exterior to said interior thermal zone, both of said hard disk drive, when said condensation danger is affirmed.

19. A method of manufacturing said thermal controller of claim 17, comprising:
providing thermal processor to create said thermal controller.

20. The thermal controller as a product of the process of claim 19.

21. The thermal processor of claim 11, comprising at least one member of the group consisting of:
means for second receiving said temperature reading and said humidity reading from said embedded circuit;
means for third receiving said temperature reading and said humidity reading from said temperature sensor and said humidity sensor; and
means for sensing said heat-up control to alert said thermal controller.

22. The thermal processor of claim 21, further comprising:
means for determining said condensation danger based upon said temperature reading and said humidity reading; and
means for stimulating said thermoelectric device to transfer heat from said exterior to said interior thermal zone, both of said hard disk drive, when said condensation danger is affirmed.

23. The thermal processor of claim 22, wherein at least one member of the second thermal controller means group includes at least one instance of said controller.
wherein said second thermal controller means group, consists of: said means for second receiving, said means for third receiving, said means for sensing, said means for determining and said means for stimulating.

24. A method of manufacturing said thermal processor of claim 23, comprising:
providing at least one member of said second thermal controller means group to create said thermal processor.

25. The thermal processor as a product of the process of claim 24.

26. The hard disk drive using at least one member of the controller group consisting of: said embedded circuit and said thermal controller of claim 11, comprising:
at least one of said members of said controller group coupled with said temperature sensor and said humidity sensor;
at least one of said members of said controller group coupled with said thermoelectric device; and
said thermoelectric device thermally coupled to said interior thermal zone of said hard disk drive and to said exterior region of said hard disk drive.

27. The hard disk drive of claim 26, further comprising:
said embedded circuit coupled with said temperature sensor and said humidity sensor; and
said embedded circuit coupled with said thermoelectric device to stimulate said thermoelectric device to transfer heat from said exterior to said interior thermal zone of said hard disk drive when said condensation danger is affirmed.

28. The hard disk drive of claim 26, further comprising:
said embedded circuit coupled with said temperature sensor and said humidity sensor;
said thermal controller coupled with said thermoelectric device to stimulate said thermoelectric device to transfer heat from said exterior to said interior thermal zone of said hard disk drive when said condensation danger is asserted.

29. The hard disk drive of claim 28, wherein said embedded circuit provides at least one member of a signal group to said thermal controller;
wherein said signal group, consists of: said heat-up control, a version of said humidity reading, and a version of said temperature reading.

30. The hard disk drive of claim 26, further comprising:
said thermal controller coupled with said temperature sensor and said humidity sensor;
said thermal controller coupled with said thermoelectric device to stimulate said thermoelectric device to transfer heat from said exterior to said interior thermal zone of said hard disk drive when said condensation danger is asserted.

31. The hard disk drive of claim 30, further comprising: a second of said temperature sensors and a second of said humidity sensors, both coupled to said embedded circuit.

32. The hard disk drive of claim 26, further comprising at least one member of the group consisting of: a third of said temperature sensors and a third of said humidity sensors, where said member samples said exterior of said hard disk drive.

33. A method of manufacturing said hard disk drive of claim 26, comprising the steps:
coupling said at least one member of said controller group to said temperature sensor and said humidity sensor to provide said temperature reading and said humidity reading;
coupling said at least one member of said controller group to said thermoelectric device to create said hard disk drive.

34. The hard disk drive as a product of the process of claim 33.

35. The method of claim 33, wherein the step coupling said at least one member of said controller group to said temperature sensor and said humidity sensor, further comprises a member of the group consisting of the steps:
coupling said embedded circuit to said temperature sensor and said humidity sensor to provide said temperature reading and said humidity reading;
coupling said thermal controller to said temperature sensor and said humidity sensor to provide said temperature reading and said humidity reading; and
coupling both said embedded circuit and said thermal controller to said temperature sensor and said humidity sensor to provide said temperature reading and said humidity reading.

36. The method of claim 33, wherein the step coupling said at least one member of said controller group to said thermoelectric device to create said hard disk drive, further comprises a member of the group consisting of the steps:
coupling said embedded circuit to said thermoelectric device to create said hard disk drive; and
coupling said thermal controller to said thermoelectric device to create said hard disk drive.

37. The hard disk drive of claim 26, wherein said thermoelectric device includes at least one instance of at least one member of the group consisting of: a semiconductor device and a thermal-resistive device.
